(19) United States
(12) Patent Application Publication
(10) Pub. No.: US 2005/0216499 A1
(43) Pub. Date: Sep. 29, 2005

(54) System and method for multiple table entry selections

(76) Inventors: Kenneth J. Parzygnat, Apex, NC (US); John H. Fraleigh, Cary, NC (US); Robert T. Uthe, Morrisville, NC (US)

Correspondence Address: COATS & BENNETT, PLLC, P O BOX 5, RALEIGH, NC, 27602, US

(21) Appl. No.: 10/809,129

(22) Filed: Mar. 25, 2004

(51) Int. Cl. G06F 17/00

(52) U.S. Cl. 707/102

(57) ABSTRACT

Multiple entries in a table are selected or deselected by designating a particular data field of a first entry. The selection state of other entries, the content of whose corresponding data field matches that of the first entry, is toggled. The data field may be designated by selecting a data field designation glyph in a web interface, by mouse-selecting a data field with a unique keyboard and/or mouse input, or by directing the table focus to a data field and entering a unique keyboard and/or mouse input. The desired entries need not be contiguous, and need not be visibly displayed in the table.

### BACKGROUND

The present invention relates generally to the field of software and in particular to a system and method for easily selecting multiple entries in a table.

In a broad variety of software applications, a well known and commonly used structure for displaying data is a two-dimensional table that organizes the data in a series of horizontal rows and vertical columns. For example, tables may be used to display information to a user on a computer display device, such as a monitor or screen, either utilizing the full-screen display or in a Graphic User Interface (GUI) window. Tables are also commonly used to display data via a World Wide Web interface. Generally, a table entry must be selected, or receive the table focus, prior to executing some command or performing some operation on the entry (e.g., delete, save, format, or the like).

Several paradigms are known in the art for allowing a user to select one or more table entries. The most common is simply selecting an entry by first moving a cursor over some portion of the entry, and then executing a mouse-click (a process referred to herein as a mouse-selection). Depending on the application, this may select only the data field (e.g., cell) over which the cursor is positioned (such as in a spreadsheet application), or it may select the entire table entry (e.g., row, such as in a GUI file system browser window). With respect to tables displayed across a web interface, a user must generally mouse-select a check-box or similar icon associated with each table entry to indicate selection of the entry. As an alternative to mouse-selecting, many applications allow the user to move the selection, or current table data field focus, among data fields in response to keyboard commands, such as for example the horizontal and vertical directional arrow keys.

Simultaneously selecting a plurality of table entries, such as to perform an operation on all selected entries together, is generally more cumbersome than selecting a single table entry, particularly if the desired entries are not contiguous in the table. In a web interface, the user must separately mouse-select each desired table entry, which is time-consuming and error-prone, particularly for a large number of table entries. Many GUI windows support selecting multiple non-contiguous table entries by the CTRL-MouseClick combination, and support selecting multiple contiguous table entries by mouse-selecting a first entry, moving or scrolling to the last desired entry, and entering a SHIFT-MouseClick combination to select all intervening entries. While this is convenient in some situations, it requires that the tabular display of entries be manipulated in some way to arrange all desired table entries to be contiguous.

### SUMMARY

The present invention relates to a method of selecting (or deselecting) a plurality of table entries based on the entries' data. The method includes displaying entries, each entry having at least one data field, in a table; accepting designation of a data field of a particular entry by a user; and for other entries in the table, the content of whose corresponding data field matches that of the particular entry, toggling a selection state of the table entries.

### BRIEF DESCRIPTION OF DRAWINGS

FIG. 1 is a functional block diagram of a computer system.

FIG. 2 is a representative table as viewed via a web interface.

FIG. 3 is the table of FIG. 2 with data field selection glyphs added.

FIG. 4 is a representative GUI environment file system browser window.

FIG. 5 is a flow diagram depicting a method of selecting table entries.

### DETAILED DESCRIPTION

The present invention relates to a method of selecting (or deselecting) multiple table entries based on the content of the entries. According to the present invention, a user may designate a first table entry by selecting a data field of the first entry (e.g., a cell of the table). Upon entering a data field designation input command, all table entries (whether currently displayed or not), the contents of whose corresponding data field match that of the first entry, are simultaneously selected (or, if previously selected, are deselected). The set of table entries may then be acted on as a group.

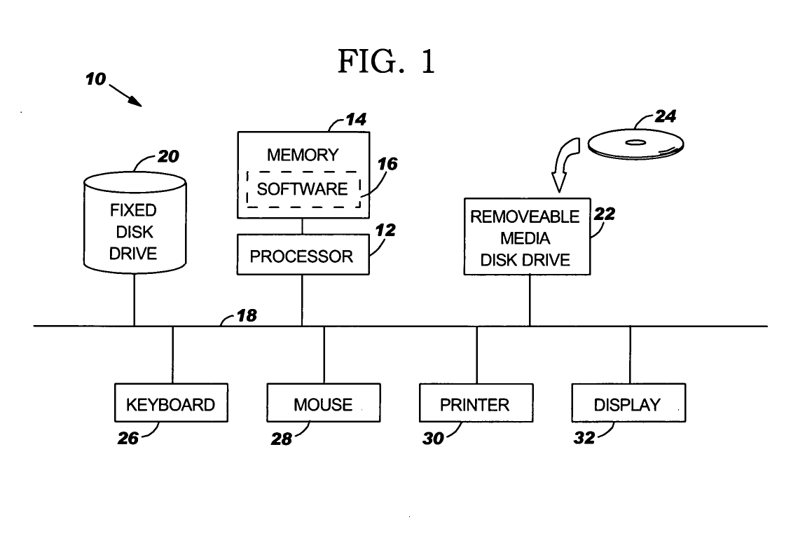

FIG. 1 depicts a functional block diagram of a representative computer system, indicated generally by the numeral 10. The computer system 10 includes a processor 12 capable of executing stored instructions. Connected to the processor 12 is memory 14 that, in operation, stores software 16. Software 16 may include, in addition to operating systems and the like, one or more applications that display data to a user in a tabular format. A spreadsheet application is one example of an application that displays tabular data.

The processor 12 is connected to a bus 18, to which are connected a variety of data storage devices and input and output devices. For example, a fixed disk drive 20 containing a computer-readable medium, from which software 16 may be loaded into memory 14, may be attached to the bus 18. Additionally, a removable media disk drive 22 that receives removable computer-readable media 24 may be attached to the bus 18. The removable media 24 may comprise a floppy disk, a CD-ROM or DVD-ROM, a magnetic tape, high-capacity removable media, or the like. Removable media 24 may contain a variety of digital data, and in particular may contain software 16, such as applications that, in operation, display data to a user in a tabular format. The software 16 may be copied from the removable media 24 to the fixed disk drive 20, and subsequently loaded into memory 14 from the fixed disk drive 20. Alternatively, the software 16 may be loaded directly from the removable media 24 into the memory 14.

Also connected to the bus 18 are input devices such as a keyboard 26 and a mouse 28, as well known in the art. The computer system 10 may additionally include output devices such as a printer 30 or display device 32. Display device 32 may comprise a traditional CRT monitor, a liquid crystal display (LCD), or the like.

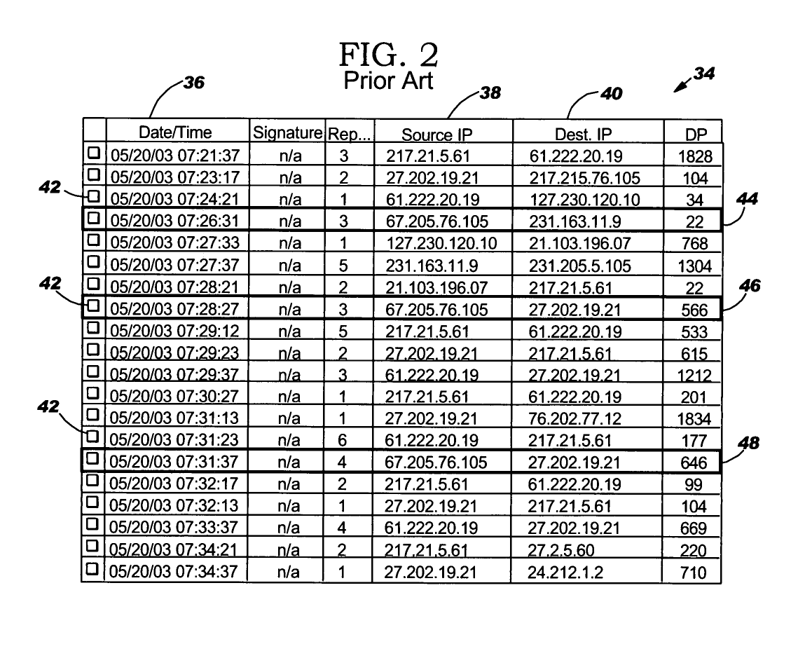

In operation, software 16 executing on the computer system 10 displays data in a tabular format to a user via the display device 32. FIG. 2 depicts a representative prior art table display, indicated generally by the numeral 34. The table comprises a plurality of table entries, each table entry organized as a row. Each table entry comprises a plurality of data fields, organized in the table 34 as a plurality of columns. In this example, the table displays online software distribution information, wherein each table entry corresponds to an instance of software, and data fields of the table entry contain information relating to the distribution of that software, such as a time stamp 36, the source IP address 38, and the destination IP address 40, among other data fields. The table 34 is depicted in FIG. 2 as it may appear across a web interface. A selection box icon 42 is associated with each table entry. To select one or more table entries, a user must independently mouse-select the icon 42 associated with each desired table entry.

In many situations, a user may wish to select multiple table entries based on the contents of a data field. For example, with respect to the table 34, a user may wish to extract all instances of software distributed from a particular source IP address. Under prior art systems such as that depicted in FIG. 2, the user must manually inspect the contents of the source IP data field 38 for each table entry, mouse-clicking the selection icon 42 associated with those table entries for which the source IP address matches, for example, table entries 44, 46, and 48. This method of selecting the desired table entries is cumbersome, non-intuitive, time-consuming, and error-prone.

In applications that do not utilize a web interface, such as for example, an application running in a GUI window, the user may not necessarily be required to independently select each desired table entry 44, 46, 48. The user could, for example, mouse-select the header of column 38, which has the effect in many GUI applications of sorting the table entries based on the contents of column 38 (i.e., the associated data fields of the table entries). This would display the table entries 44, 46, 48- and any other table entries having the same source IP address—contiguously. The user may then individually mouse-select the table entries 44, 46, 48, or alternatively may select the first entry and SHIFT-MouseClick the last entry to select the desired table entires. However, even this process requires that the user re-sort the table to arrange the table entries into an order that facilitates easy multiple selection.

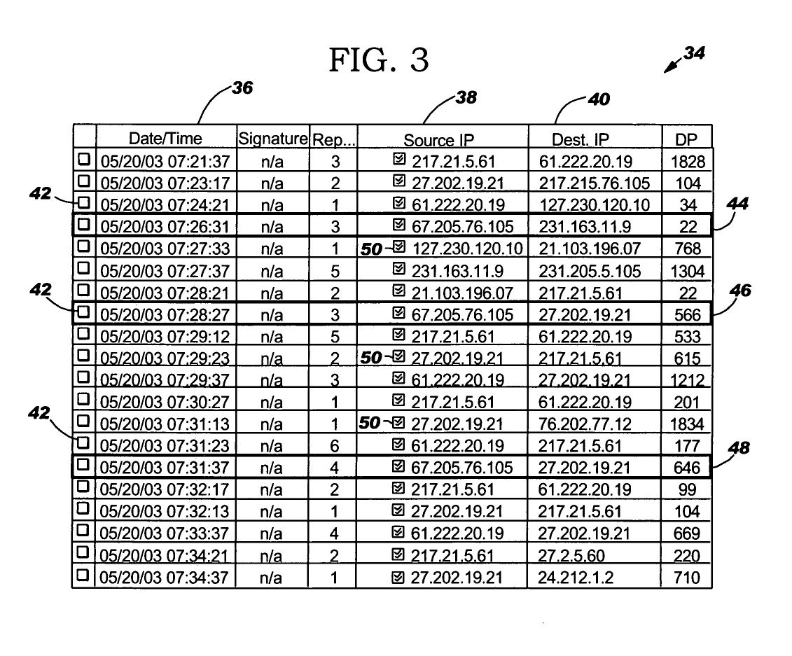

FIG. 3 depicts the web interface table 34, with the addition of data field content selection glyphs 50 associated with the source IP address data field of each table entry. According to the present invention, the user may mouse-select one of the glyphs 50, for example, that associated with the data entry 44. This causes the application displaying the table to perform a search of the corresponding data fields of all table entries, automatically selecting those table entries whose source IP address data field match that of table entry 44—in this example, table entries 46 and 48.

The glyphs 50 of the web interface table 34 are necessary to designate a table entry data field against which other entries within the table are to be compared for table entry selection due to the constraints of the web interface. Applications running on other interfaces may not require data field content selection glyphs 50. For example, with respect to a table displayed in a GUI window, a unique keystroke, such as CTRL-SHIFT-MouseClick, CTRL-ALT-MouseClick or the like, may be used to designate a data field. As still another alternative, for example with respect to a spreadsheet application, the current table focus may be directed to the desired data field, such as by use of the horizontal and vertical direction keys. Once the desired data field has received the table focus, a unique keystroke combination, such as for example CTRL-ALT-Enter, may be entered to designate the data field for table entry selection. Preferably, both the mouse-selection input and the keyboard input are keystroke and/or mouse click combinations that are not otherwise recognized or operated on by the applications displaying the table entries.

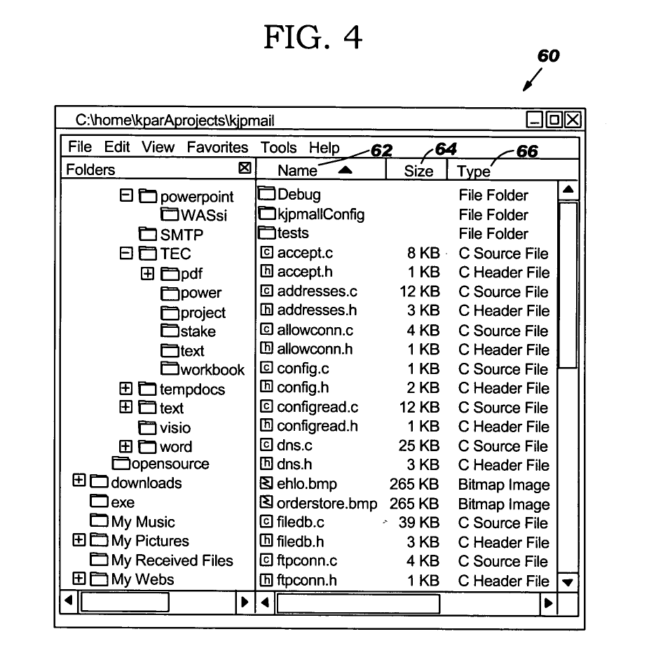

FIG. 4 depicts a file system browser application running in a GUI window, indicated generally by the numeral 60. In the right-hand panel, the contents of a selected directory are displayed in a tabular form, with each table entry having data fields labeled File name 62, Size 64 and Type 66. The object count in the lower left-hand corner of the GUI window indicates that the directory listing comprises 105 files. A user may wish to copy all C Source files in the directory to another directory or a floppy disk. Under prior art table entry selection methods, the user would have to individually select each C Source file, or alternatively, sort the display by the type column 66, and group-select the contiguous C Source file table entries. According to the present invention, the user may designate the “C Source file” data field of a single table entry to automatically select all table entries, the content of whose corresponding data field match. That is, in response to a single designation (in this case, a unique mouse-select command), all C files in the directory are selected and the user may simply drag the files to a desired directory or drive, copy them, delete them, or perform some other desired operation.

The above examples of applications of the present invention are illustrative only and not limiting. In general, the present invention finds utility in a broad variety of applications. For example, a user may utilize the present invention in the tabular display of an e-mail client to quickly select all messages from a particular e-mail address, all messages having a particular subject line, or the like.

While the present invention has been explained with respect to selecting table entries for performing subsequent operations, the invention is fully applicable to the de-selection of a plurality of table entries based on data field contents. For example, with respect to FIG. 4, a user may wish to “clean out” all files from the selected directory that are not C Source files. In this case, the user may initially select all of the files, either by a menu command to that effect, by a shortcut such as CTRL-A, or by using the SHIFT-MouseClick contiguous multiple selection. The user may then designate the C Source file data field of one table entry (i.e., one file), thus de-selecting all C Source files. The user may then easily delete the remaining files.

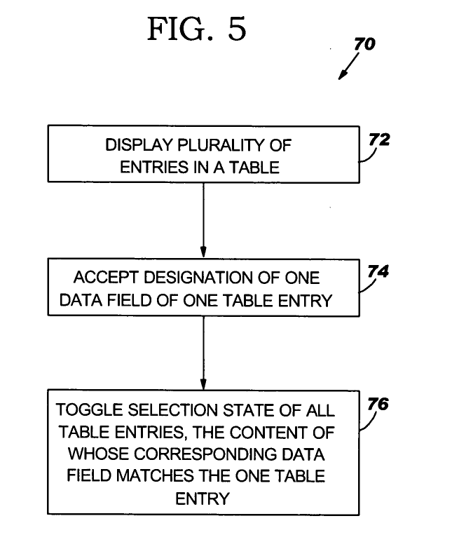

FIG. 5 depicts a flow diagram representation of a table entry selection method according to the present invention, indicated generally by the numeral 70. This method may be implemented as a software application. A table comprising a plurality of entries is displayed at step 72. A designation of one data field of one table entry by the user is accepted at step 74. The designation of a data field may comprise a user selecting a data field designation glyph in a web interface. Alternatively, it may comprise a user indicating a data field (such as by cursor position or table focus) and entering a data field designation input command (such as a unique keystroke and/or mouse input combination).

According to the method, the table entry containing the designated data field, and all other table entries in the table, the content of whose corresponding data field matches that of the designated entry, toggle their selection state in response to the designation, at step 76. That is, if no table entries were selected, the designated entry and those matching its designated data field are selected. Conversely, if all of the table entries were selected, the designated entry and those matching its designated data field are de-selected. Note that the selected or deselected entries need not be visibly displayed in the table. Following the plural selection or de-selection, the user may proceed to perform operations on the desired table entries—or the table entries other than the desired entries—as a group.

As used herein, a “table” is any display of data that is organized and/or displayed in a tabular, or array, format. A table comprises a plurality of table entries, each of which includes one or more data fields. A table need not explicitly define or display rows and columns, and need not display a border or boundary between table elements or data fields thereof. As used herein, a table “entry” is a collection of related data, organized in at least one data field, which is displayed along with other entries in a tabular format. Typically, each entry is displayed in a table row, and its constituent data fields are displayed in table columns; however, it is known in the art to display table entries spanning two or more rows. As used herein, the “selection state” of a table entry is one of selected or not selected—that is, the entry is or is not, respectively, in a group (which may comprise one entry) that has a focus or property such that one or more subsequent operations or functions will apply to all of the entries in the group. As used herein, “toggling” the selection state of one or more table entries means to reverse its selection state—that is, to switch its state either from not selected to selected, or from selected to not selected.

Although the present invention has been described herein with respect to particular features, aspects and embodiments thereof, it will be apparent that numerous variations, modifications, and other embodiments are possible within the broad scope of the present invention, and accordingly, all variations, modifications and embodiments are to be regarded as being within the scope of the invention. The present embodiments are therefore to be construed in all aspects as illustrative and not restrictive and all changes coming within the meaning and equivalency range of the appended claims are intended to be embraced therein.

1. A method of toggling the selection state of a plurality of table entries based on the entries' data, comprising:
displaying entries, each having at least one data field, in a table;
accepting the designation of a data field of a first entry by a user; and
for entries in said table, the content of whose corresponding data field matches that of said first entry, toggling a selection state of said entries.

2. The method of claim 1 wherein accepting the designation of a data field of a first entry by a user comprises accepting a data field designation input command when said data field is indicated.

3. The method of claim 2 wherein said data field designation input command comprises a qualifier key in combination with a mouse-click.

4. The method of claim 2 wherein said data field is indicated by placing a cursor over said data field.

5. The method of claim 2 wherein said table has a table entry data field focus, and wherein said data field is indicated by directing the table entry data field focus to said data field.

6. The method of claim 1 wherein entries in said table include entries not visibly displayed in said table.

7. A computer system, including:
a display device;
at least one input device;
a processor programmed to display entries, each having at least one data field, in a table, said processor operative to allow a user to designate a data field of a first entry in said table and further operative to toggle a selection state of other entries in said table, the content of whose corresponding data field matches that of said first entry.

8. The system of claim 7 wherein a user designating a data field of a first entry in said table comprises the user inputting a data field designation input command when said data field is indicated.

9. The system of claim 8 wherein said data field designation input command comprises a qualifier key in combination with a mouse-click.

10. The system of claim 8 wherein said data field is indicated by placing a cursor over said data field in said table.

11. The system of claim 8 wherein said table has a table entry data field focus and wherein said data field is indicated by directing said table entry data field focus to said data field.

12. The system of claim 7 wherein other entries in said table include entries not visibly displayed in said table.

13. A computer-readable medium that stores computer-executable process steps for toggling the selection state of a plurality of table entries based on the entries' data, said computer-executable process steps causing a computer to perform the steps of:
displaying entries, each having at least one data field, in a table;
accepting designation of a data field of a first entry by a user; and
for entries in said table, the content of whose corresponding data field matches that of said first entry, toggling the selection state of said entries.

14. The computer-readable medium of claim 13 wherein accepting the designation of a data field of a first entry by a user comprises accepting a data field designation input command when said data field is indicated.

15. The computer-readable medium of claim 14 wherein said data field designation input command comprises a qualifier key in combination with a mouse-click.

16. The computer-readable medium of claim 14 wherein said data field is indicated by placing a cursor over said data field.

17. The computer-readable medium of claim 14 wherein said table has a table entry data field focus and wherein said data field is indicated by directing the table entry data field focus to said data field.

18. The computer-readable medium of claim 13 wherein other entries in said table include entries not visibly displayed in said table.
